(19) United States
(12) Patent Application Publication
(10) Pub. No.: US 2011/0075584 A1
(43) Pub. Date: Mar. 31, 2011

(54) SWITCH DEVICE AND LOOP DETECTION METHOD IN A RING NETWORK SYSTEM

(76) Inventor: SHUJI TERAMOTO, Tokyo (JP)

(21) Appl. No.: 12/891,911

(22) Filed: Sep. 28, 2010

(30) Foreign Application Priority Data
Sep. 28, 2009 (JP) 2009-222548

(51) Int. Cl. H04L 12/26; H04W 4/00

(52) U.S. Cl. 370/252; 370/328

(57) ABSTRACT

A switch device used in a ring network operating based upon a protocol prescribed to prevent a loop from occurring includes: a transmission section that periodically transmits a predetermined control frame defined in the protocol out to a communication line in the ring network; a reception section that receives a control frame from the ring network; and a determination section that determines the occurrence of a loop when source address information in the received control frame is identical to address information on the transmission section and also when the received control frame is a predetermined control frame defined in the protocol.

This application is based upon and claims the benefit of priority from Japanese Patent Application No. 2009-222548, filed on Sep. 28, 2009, the disclosure of which is incorporated herein in its entirety by reference.

### BACKGROUND OF THE INVENTION

1. Field of the Invention

The present invention relates to a ring network system operating based upon a protocol prescribed to prevent a loop from occurring and, more particularly, to a loop detection method and a switch device having a loop detection function used in the ring network system.

2. Description of the Related Art

In general, when Ethernet™ is used in carrier networks, widely used are IEEE 802.3ad Link Aggregation (LAG) for redundancy of links between adjacent devices, and IEEE 802.1D Spanning Tree Protocol (STP) for network-wide node and link redundancy.

However, these protocols are originally designed for local area networks (LAN) and therefore have some disadvantages in terms of reliability and maintainability, such as service interruption time and ease in maintenance, which have been the factors to prevent Ethernet equipment from becoming popular in carrier markets. Many communication carriers demand reliability and maintainability comparable with those of multiplex section protection (MSP), subnetwork connection protection (SNCP), and multiplex section protection ring (MSPRing), which are established based on conventional synchronous digital hierarchy (SDH) technologies. International telecommunication union telecommunication standardization sector (ITU-T) is working on the establishment of G.8032 as a protection technology for implementing these demands.

According to ITU-T recommendation G.8032, failure detection and exchanges of control information are performed utilizing Ethernet OAM (Operations, Administration, Maintenance), thereby realizing failure switching and revertive processing within 50 msec. ITU-T recommendation G.8032 also provides various maintenance functions such as command-based switching/reverting and state freezing, thus implementing protection switching in a single ring network or between ring networks.

The protocol according to ITU-T recommendation G.8032 is prescribed so that a loop is methodologically prevented from occurring. In a ring network, a predetermined node is designated as a ring protection link (RPL) owner, which steadily blocks a RPL port, whereby communication between nodes is performed by using a path excluding the RPL port. That is, the protocol is designed to prevent the occurrence of a loop by steadily blocking a RPL port so that a ring is logically disconnected. This will be described in more detail later.

Further, a variety of loop detection methods are proposed for use in a ring network. For example, according to a system disclosed in Japanese Patent Application Unexamined Publication No. 2004-320248, when frames having the same source MAC address are received from different receiving links within a very short time, it is determined that a loop occurs outside the device.

According to a loop detection method disclosed in Japanese Patent Application Unexamined Publication No. 2007-124184, one switch in a network broadcasts a loop detection frame, and a switch that has received the loop detection frame transfers the frame including the address of the sending interface. At that time, however, if the address of the interface of its own switch is already registered, the switch detects the occurrence of a loop and performs processing for blocking the interface in question and the like.

According to a network monitoring method disclosed in Japanese Patent Application Unexamined Publication No. 2008-067306, a monitoring packet is transmitted to a network to be monitored, and it is determined whether or not a loop occurs in the network, based on the source address of the monitoring packet received.

However, although the protocol according to ITU-T recommendation G.8032 is prescribed to methodologically prevent a loop from occurring, there are some occasions when a loop occurs if the system falls in a state out of normal control due to runaway of software, failure of CPU, or the like. When a loop occurs as described above without the prescribed loop occurrence prevention properly functioning, a frame may infinitely circulate within the network, causing an adverse effect of pressing user traffic.

The above-mentioned loop detection technology described in Japanese Patent Application Unexamined Publication No. 2004-320248 is configured to compare the source addresses and times of receipt of two successively received frames, thereby determining whether or not the second received frame is a loop frame. Accordingly, it is necessary to provide a timer and a received frame counter for loop detection.

The above-mentioned loop detection technology described in Japanese Patent Application Unexamined Publication No. 2007-124184 is configured to detect a loop in such a manner that each switch device connected to a network sequentially transmits a loop detection frame. Accordingly, a frame dedicated to loop detection, the loop detection frame, is required. Transmission of such a dedicated frame reduces the available band in the network and puts pressure on user traffic.

According to Japanese Patent Application Unexamined Publication No. 2008-067306 as well, loop detection is performed by transmitting a monitoring packet over a network. Accordingly, similarly to the technology according to Japanese Patent Application Unexamined Publication No. 2007-124184, a frame dedicated to loop detection is required, putting pressure on user traffic.

### SUMMARY OF THE INVENTION

The present invention is made in light of the situations described above, and an object thereof is to provide a switch device and a loop detection method that can certainly detect the occurrence of a loop without increasing the load on a network even when loop occurrence prevention does not function in a ring network system using a protocol prescribed to prevent a loop from occurring.

According to the present invention, a switch device in a ring network operating based on a protocol prescribed to prevent occurrence of a loop, includes: a transmission section for periodically transmitting a predetermined control frame to a communication line of the ring network, wherein the predetermined control frame conforms to the protocol; a reception section for receiving a control frame from the ring network; and a determination section for determining the occurrence of a loop on the communication line when a source address of a received control frame is identical to an address of the transmission section and the received control frame is a predetermined control frame conforming to the protocol.

According to the present invention, a loop detection method in a switch device of a ring network operating based on a protocol prescribed to prevent occurrence of a loop, includes the steps of: at a transmission section, periodically transmitting a predetermined control frame to a communication line of the ring network, wherein the predetermined control frame conforms to the protocol; and at a determination section, determining the occurrence of a loop on the communication line when a source address of a control frame received from the ring network is identical to an address of the transmission section and the received control frame is a predetermined control frame conforming to the protocol.

According to the present invention, a recording medium storing a program which instructs a computer to function as a switch device of a ring network operating based on a protocol prescribed to prevent occurrence of a loop, the program includes: at a transmission section, periodically transmitting a predetermined control frame to a communication line of the ring network, wherein the predetermined control frame conforms to the protocol; and at a determination section, determining the occurrence of a loop on the communication line when a source address of a control frame received from the ring network is identical to an address of the transmission section and the received control frame is a predetermined control frame conforming to the protocol.

As described above, according to the present invention, even when loop occurrence prevention according to a prescribed protocol does not function, it is possible to certainly detect the occurrence of a loop without increasing the load on a network.

### BRIEF DESCRIPTION OF THE DRAWINGS

FIG. 1A is a network diagram showing communication operation under normal conditions when the control based on the protocol according to ITU-T recommendation G.8032 is normally performed.

FIG. 1B is a network diagram showing communication operation upon occurrence of a failure when the control based on the protocol according to ITU-T recommendation G.8032 is normally performed.

FIG. 1C is a network diagram showing path switching operation when the control based on the protocol according to ITU-T recommendation G.8032 is normally performed.

FIG. 2 is a network diagram showing a loop state caused by an abnormality occurring in the control based on the protocol according to ITU-T recommendation G.8032.

FIG. 3 is a block diagram showing a configuration of a switch device according to a first exemplary embodiment of the present invention.

FIG. 4 is a diagram showing a Ring-APS control frame format used in the present exemplary embodiment.

FIG. 5 is a flowchart showing loop detection operation according to the first exemplary embodiment.

FIG. 6 is a block diagram showing a configuration of a switch device according to a second exemplary embodiment of the present invention.

FIG. 7 is a flowchart showing loop detection operation according to the second exemplary embodiment.

FIG. 8 is a flowchart showing loop detection operation according to a third exemplary embodiment of the present invention.

### DETAILED DESCRIPTION OF THE PREFERRED EMBODIMENTS

For Ethernet ring networks defined in ITU-T recommendation G.8032, as discussed earlier, the occurrence of a loop is prevented according to the prescribed protocol. Hereinafter, a brief description will be given of loop occurrence prevention control according to the prescribed protocol of ITU-T recommendation G.8032.

### 1. Prescribed Loop Occurrence Prevention Control

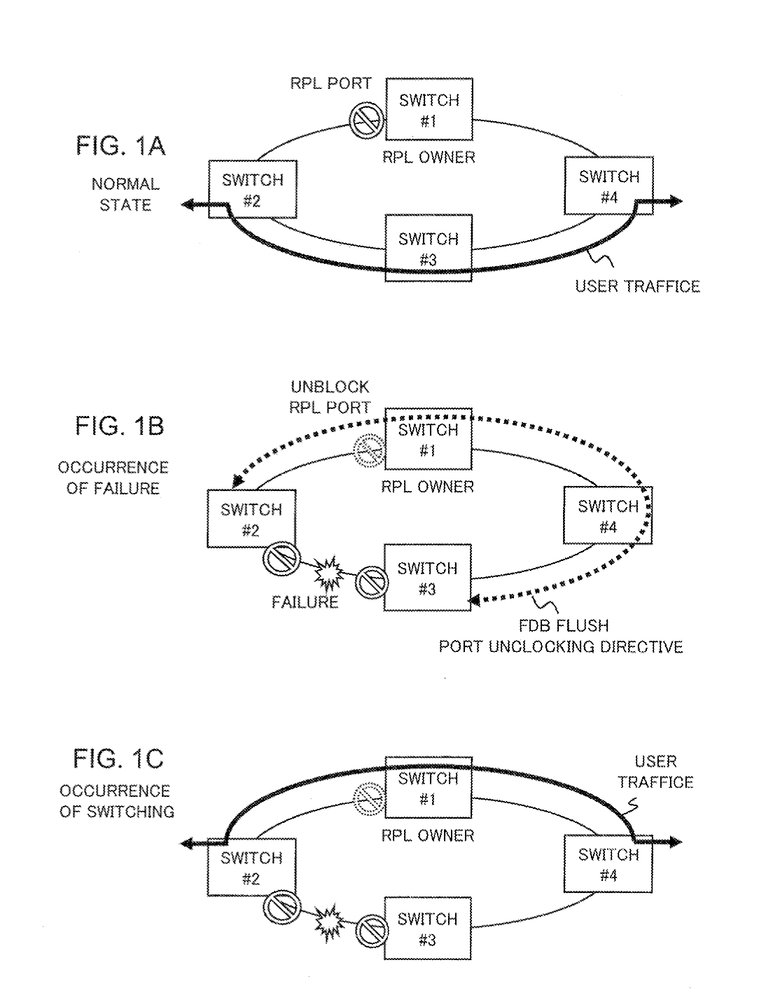

To simplify the description, it is assumed that an Ethernet ring network includes four switch devices (nodes) #1 to #4 as shown in FIGS. 1A to 1C.

Under the normal state as shown in FIG. 1A, one point arbitrarily determined in a physically closed loop is steadily blocked as a ring protection link (RPL) port. Communication of each node is performed using a path excluding the RPL port. A node having the RPL port (here, the switch device #1) is a RPL owner and periodically transmits a Ring-APS control frame, which is a control frame. Non-RPL owner nodes (here, switch devices #2 to #4) do not originate a Ring-APS control frame.

Referring to FIG. 1B, assuming that a failure occurs between the switch devices #2 and #3, the nodes adjacent to the point of failure (switch devices #2 and #3) block the respective corresponding failure ports. Then, filtering database (hereinafter referred to as FDB) flush is performed to clear old path information, switching to a new path. Thereafter, the switch device #1 unblocks the RPL port.

Referring to FIG. 1C, when path switching has taken place, the ring network system allows the distribution path of user traffic to switch to a path excluding the section in which the failure has occurred. That is, in this example, user traffic is switched from the normal-state path passing through the switch devices #2, #3, and #4 as shown in FIG. 1A, to the path after switching, passing through the switch devices #2, #1, and #4 as shown in FIG. 1C.

As described above, according to the provisions of ITU-T recommendation G.8032, the occurrence of a loop is prevented by blocking the RPL port during normal state, and upon the occurrence of a failure in the ring, paths are switched and the RPL port is unblocked to keep user traffic.

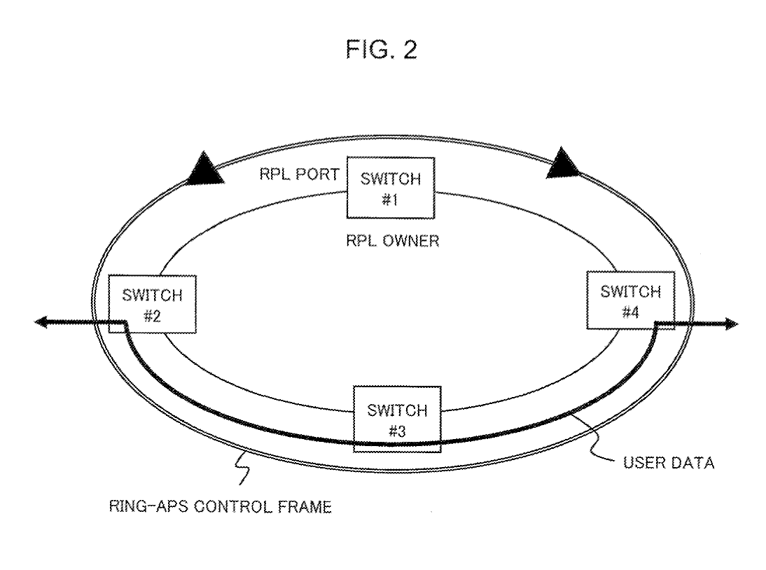

However, as mentioned earlier, if the system falls in a state out of normal control due to runaway of software, failure of CPU, or the like in the switch device #1 that is the RPL owner, there are some occasions when a loop occurs, with a frame circulating infinitely in the ring network as shown in FIG. 2. The occurrence of such a loop may press and affect user traffic.

The present invention aims to certainly and quickly detect the occurrence of a loop and avoid affecting the network even when stopping of a loop according to a prescribed protocol having loop occurrence prevention function like ITU-T recommendation G.8032 does not function. Hereinafter, exemplary embodiments of the present invention will be described in detail.

### 2. First Exemplary Embodiment

2.1) Configuration

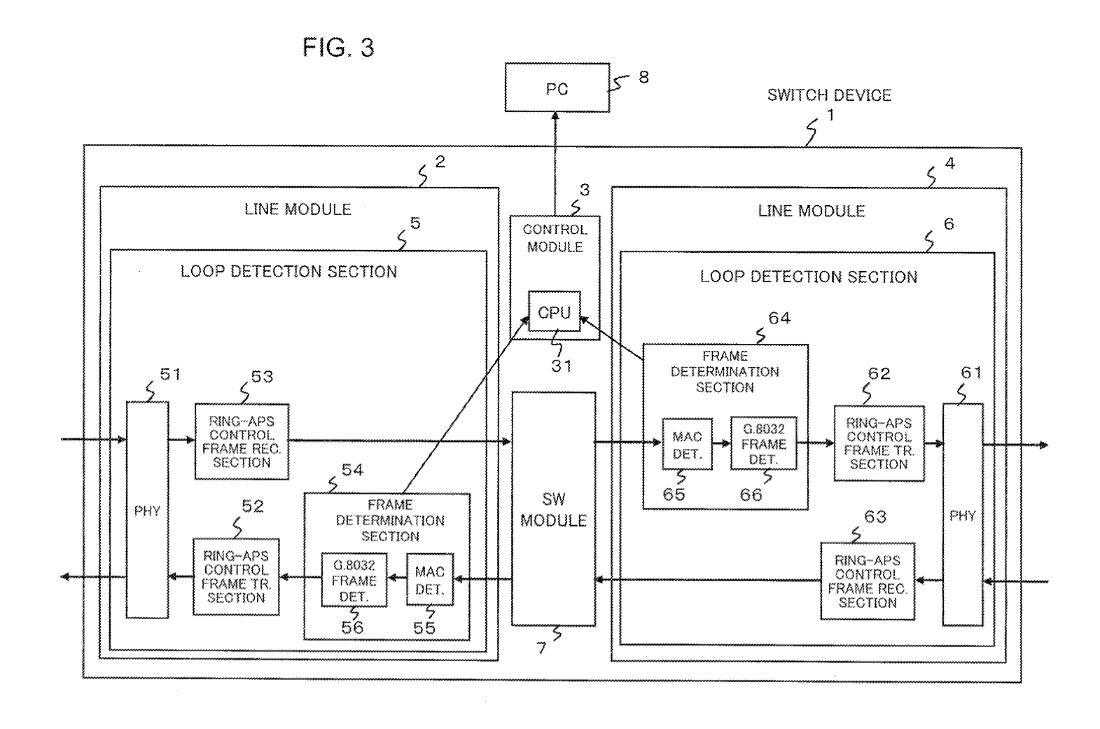

Of the switch devices included in the ring network, a description will be given of a switch device 1, which is designated as a RPL owner, with reference to FIG. 3. Here, it is assumed that the switch device 1 is connected to two communication lines included in the ring network and that the communication lines transmit signals in the opposite directions to each other.

Referring to FIG. 3, the switch device 1 includes line modules 2 and 4 that have various line interfaces including one for Ethernet, a control module 3 that performs communication control on each line module, system monitoring, and the like, and a switch module 7 that performs switching control well known for a switch device. The line module 2 connected to one link is provided with a loop detection section 5, and the line module 4 connected to the other link is provided with a loop detection section 6.

The loop detection section 5 includes a physical interface (PHY) 51 connected to the one link, a Ring-APS control frame transmission section 52, a Ring-APS control frame reception section 53, and a frame determination section 54 that determines whether or not a loop occurs. Similarly, the loop detection section 6 includes a physical interface (PHY) 61 connected to the other link, a Ring-APS control frame transmission section 62, a Ring-APS control frame reception section 63, and a frame determination section 64 that determines whether or not a loop occurs.

The flow of a signal concerning loop detection is as follows. When the line module 2 receives a signal from the one communication link, the signal is output to the switch module 7 through the PHY 51 and Ring-APS control frame reception section 53. If the signal is sent to the line module 4 by the switch module 7, it is determined by the frame determination section 64 of the loop detection section 6 whether or not a loop occurs in the communication link in question. The Ring-APS control frame transmission section 62 transmits a Ring-APS control frame out to the communication link in question through the PHY 61 at predetermined time intervals. Moreover, when the line module 4 receives a signal from the other communication link, the signal is output to the switch module 7 through the PHY 61 and Ring-APS control frame reception section 63. If the signal is sent to the line module 2 by the switch module 7, it is determined by the frame determination section 54 of the loop detection section 5 whether or not a loop occurs. The Ring-APS control frame transmission section 52 transmits a Ring-APS control frame out to the communication link in question through the PHY 51 at predetermined time intervals.

The PHYs 51 and 61 individually perform signal conversion between an electrical signal in their respective loop detection sections and a signal (e.g., optical signal) transmitted over the adjacent link.

The Ring-APS control frame transmission sections 52 and 62 individually transmit to each node in the ring network a Ring-APS control frame which is ring protection control information. Specifically, the same Ring-APS control frame is transmitted twice at an interval of 3.3 ms when the ring network is started, and thereafter, the same frame is retransmitted periodically every 5 seconds.

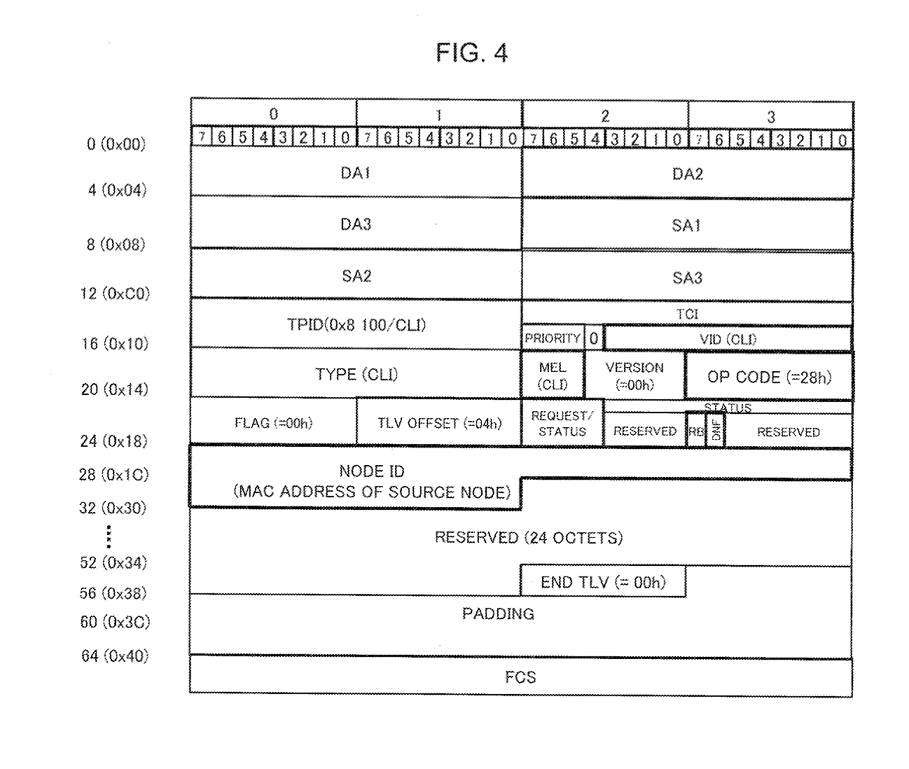

FIG. 4 shows a format of the Ring-APS control frame. The fields relevant to the present exemplary embodiment are RB (RPL Blocked) and DNF (Do Not Flush) in the Status field, VLAN ID, MEL (Maintenance Entity group Level), OpCode, and Node ID. RB is set when the RPL is blocked, and DNF is set when FDB flush is not necessary. Node ID indicates the MAC address of the source (source address information) of the Ring-APS control frame in question.

The Ring-APS control frame reception sections 53 and 63 individually terminate a received Ring-APS control frame and check whether or not any change is made in the values of the status field in the Ring-APS control frame format.

The frame determination section 54 includes a MAC determination section 55 and a G.8032 frame determination section 56. Similarly, the frame determination section 64 also includes a MAC determination section 65 and a G.8032 frame determination section 66. In addition, the frame determination sections 54 and 64 store MAC addresses, which are assigned to ports respectively, in a memory (not shown) beforehand and can confirm the numbers of their own ports.

The MAC determination sections 55 and 65 individually check the MAC address of the source (source address information) of a Ring-APS control frame and determine whether or not a Ring-APS control frame having the same MAC address as that of its own port is received.

The G.8032 frame determination sections 56 and 66 individually check VLAN ID, MEL, OpCode, and Node ID in the Ring-APS control frame format shown in FIG. 4 and determine whether or not the frame is a Ring-APS control frame defined in ITU-T recommendation G.8032. In the example shown in FIG. 4, “OpCode=28 h” indicates a Ring-APS control frame.

If the determinations made by the MAC determination section 55 and G.8032 frame determination section 56, or those made by the MAC determination section 65 and G.8032 frame determination section 66, are both positive, then the frame determination section 54 or 64 determines that the Ring-APS control frame to be output to the subsequent Ring-APS control frame transmission section 52 or 62, respectively, is a frame that was transmitted out by its own device, thus detecting the occurrence of a loop in the ring network.

In the first place, if the loop occurrence prevention according to the prescribed protocol of ITU-T recommendation G.8032 functions normally as shown in FIG. 1A, it cannot happen that a Ring-APS control frame returns to the port from which the Ring-APS control frame was transmitted out, because the RPL owner steadily blocks the RPL port.

Accordingly, the frame determination sections 54 and 64 can determine that a loop occurs when it is determined that the frame sent from the Ring-APS control frame reception sections 63 and 53, respectively, is a Ring-APS control frame that was transmitted out by its own device. Upon the detection of a loop, the frame determination sections 54 and 64 individually notify the determination result to a CPU 31, which then, upon this notification, sends notification information indicating the occurrence of a loop to a terminal (PC) 8 of maintenance and management personnel, thereby allowing a maintenance person to recognize the occurrence of a loop.

Since it is only the RPL owner node that originates a Ring-APS control frame during normal state, loop detection according to the present exemplary embodiment can be accomplished only by the RPL owner node.

2.2) Loop Detection Operation

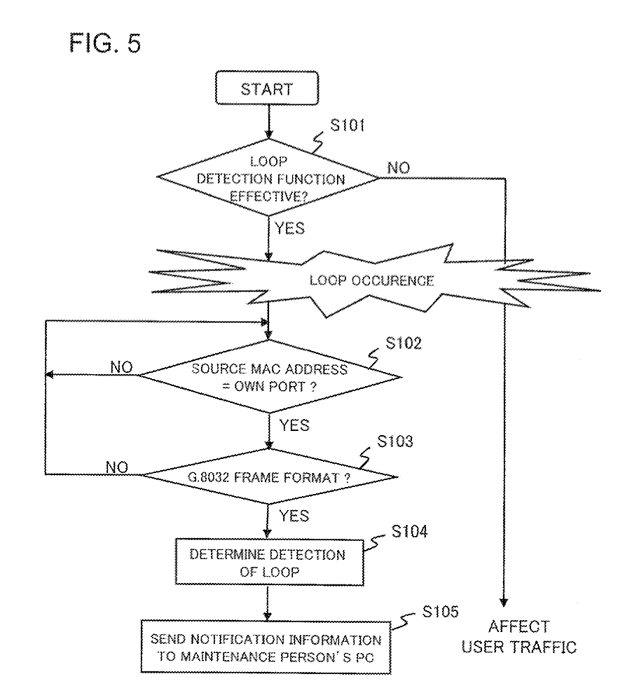

Next, a description will be given of loop detection operation performed by the switch device 1, which is assigned as a RPL owner node, with reference to the flowchart of FIG. 5.

First, a user sets the loop detection function effective or ineffective and registers this setting with the loop detection sections 5 and 6 (Step S101). When the loop detection function is set ineffective (Step S101: No), user traffic will be pressed upon the occurrence of a loop as discussed earlier.

When the loop detection function is set effective (Step S101: Yes), the respective MAC determination sections 55 and 65 of the frame determination sections 54 and 64 check the source MAC address of a frame, thereby monitoring whether or not a frame having the same MAC address as its own port is received (Step S102).

If at least one of the MAC determination sections 55 and 65 detects a frame having the same source MAC address as its own port (Step S102: YES), the G.8032 frame determination section connected to the frame determination section that has detected this frame (at least one of the G.8032 frame determination sections 56 and 66) checks VLAN ID, MEL, OpCode, and Node ID, thereby monitoring whether or not the frame is a Ring-APS control frame defined in ITU-T recommendation G.8032 (Step S103). In this monitoring, when it is determined that the frame is a defined Ring-APS control frame (Step S103: YES), the frame determination section in which this determination is made (at least one of the frame determination sections 54 and 64) determines that a loop is detected in the communication line for which the frame determination section in question is provided in the ring network (Step S104) and notifies it to the CPU 31 of the control module 3.

Upon notification of the detection of a loop, the control module 3 sends predetermined notification information to the maintenance person's PC 8 (Step S105). Confirming the occurrence of a loop, a maintenance person can perform loop avoidance work.

Note that when a loop is detected, in Step S105 described above, the notification information may be sent to a network management device (not shown), not only to the maintenance person's PC 8.

2.3) Advantages

As described above, according to the present exemplary embodiment, since each line module of the switch device is provided with the loop detection section having the function shown in FIG. 5, a loop can be certainly detected and notified to a maintenance person's PC even when a loop occurs due to a device failure or the like in a ring network operating based upon a loop occurrence prevention protocol like ITU-T recommendation G.8032.

According to the present exemplary embodiment, since transmission and detection of a Ring-APS control frame are performed only by a RPL owner node, the loop detection according to the present exemplary embodiment can be accomplished only by the RPL owner node.

Moreover, according to the present exemplary embodiment, as shown in FIG. 5, the occurrence of a loop can be certainly detected because the occurrence of a loop is detected only when the source MAC address of a received frame is the same as the MAC address of the output port and also the frame is a Ring-APS control frame defined in ITU-T recommendation G.8032. The reason is as follows. If the detection of a loop occurrence is based only on the MAC address determination, there is a possibility that an erroneous detection may be made as a ring network loop failure defined in ITU-T recommendation G.8032 by, for example, performing determination on a frame returning through an external network. On the other hand, according to the present exemplary embodiment, such an erroneous detection can be prevented, and determination can be performed only on those frames that return due to a ring network loop failure defined in ITU-T recommendation G.8032. Accordingly, the occurrence of a loop can be certainly detected.

Further, according to the present exemplary embodiment, the occurrence of a loop is detected through the above-described MAC address determination and G.8032 frame determination. Accordingly, it is possible to reduce the time taken to detect the occurrence of a loop in comparison with the methods of counting the same frames received.

Furthermore, according to the present exemplary embodiment, since the periodic Ring-APS control frame defined in the protocol of ITU-T recommendation G.8032 is utilized, a frame dedicated to loop detection or spanning tree protocol is not particularly required. Accordingly, the occurrence of a loop can be efficiently detected in a ring network operating based upon the provisions of ITU-T recommendation G.8032.

### 3. Second Exemplary Embodiment

During normal state, after input from an input port of the switch device 1, a Ring-APS control frame is terminated by the Ring-APS control frame reception section 53 or 63 and will not be further transmitted thereafter. In the loop detection according to the configuration example shown in FIG. 3, the above-described MAC address determination and G.8032 frame determination are performed on those frames that were transmitted out from the output ports (transmit port) of the Ring-APS control frame transmission sections 52 and 62.

Accordingly, it is sufficient that the frame determination sections 64 and 54 are placed at the subsequent stage of the Ring-APS control frame reception sections 53 and 63, respectively, and at the stage previous to the Ring-APS control frame transmission sections 62 and 52, respectively. Configurations are not limited to the above-described configuration example shown in FIG. 3.

3.1) Configuration

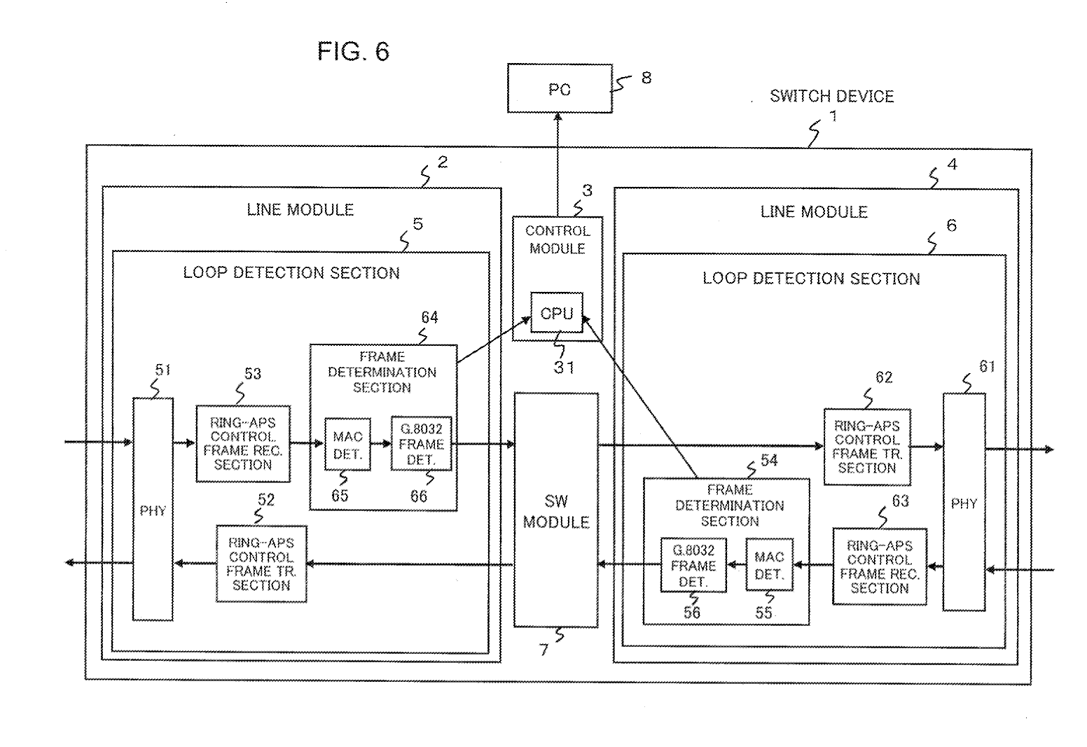

Accordingly, referring to FIG. 6, in a switch device according to a second exemplary embodiment of the present invention, the functions of the frame determination section 54 are moved into the loop detection section 6 of the line module 4, and the functions of the frame determination section 64 are moved into the loop detection section 5 of the line module 2. That is, the placement of the frame determination sections 54 and 64 is changed from immediately previous to the Ring-APS control frame transmission sections 52 and 62, respectively, as shown in FIG. 3 to immediately subsequent to the Ring-APS control frame reception sections 63 and 53, respectively, as shown in FIG. 6.

In this case, the frame determination section 54 detects a Ring-APS control frame that was transmitted from the Ring-APS control frame transmission section 52. Therefore, the frame determination section 54 stores beforehand in a memory (not shown) the MAC address of the output port for the communication line for which the Ring-APS control frame transmission section 52 is provided, that is, the MAC address of the output port on the output side of the loop detection section 5. Similarly, the frame determination section 64 stores beforehand in a memory (not shown) the MAC address of the output port for the communication line for which the Ring-APS control frame transmission section 62 is provided.

3.2) Loop Detection Operation

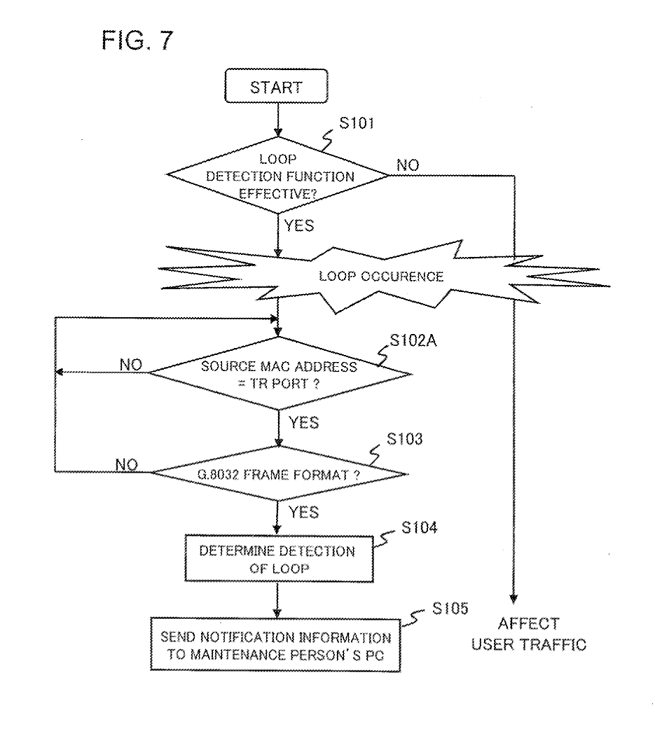

Loop detection operation according to the second exemplary embodiment of the present invention is as shown in FIG. 7. However, the operation is basically the same as the flowchart of FIG. 5, and therefore the same reference numerals are given to the same processing steps, with a detailed description thereof omitted.

Referring to FIG. 7, a processing step different from those of FIG. 5 is Step S102A, which shows the operations of the MAC determination sections 65 and 55. Specifically, as shown in FIG. 7, the MAC determination sections 65 and 55 individually check the source MAC address of a frame received from the corresponding communication line and determine whether or not the source MAC address is the same as those of the transmit ports of the corresponding Ring-APS control frame transmission sections 62 and 52, respectively (Step S102A).

When at least one of the MAC determination sections 65 and 55 detects a frame having the same source MAC address as that of the transmit port (Step S102A: Yes), determination is performed by the G.8032 frame determination section (at least one of 66 and 56), and processing similar to that of FIG. 5 is performed thereafter. Note that the effects of the present exemplary embodiment are similar to those of the first exemplary embodiment described above.

### 4. Third Exemplary Embodiment

Loop detection operation according to a third exemplary embodiment of the present invention allows the interval between transmissions of a Ring-APS control frame to be shorter than the defined interval (5 seconds) when the Ring-APS control frame reception section 53 or 63 receives the same Ring-APS control frame, by the frame determination sections 54 and 64 controlling the Ring-APS control frame transmission sections 52 and 62. Thus, it is possible to perform failure detection and protection operation more quickly. Hereinafter, the loop detection operation according to the present exemplary embodiment will be described by using the configuration of the switch device 1 shown in FIG. 6 as an example.

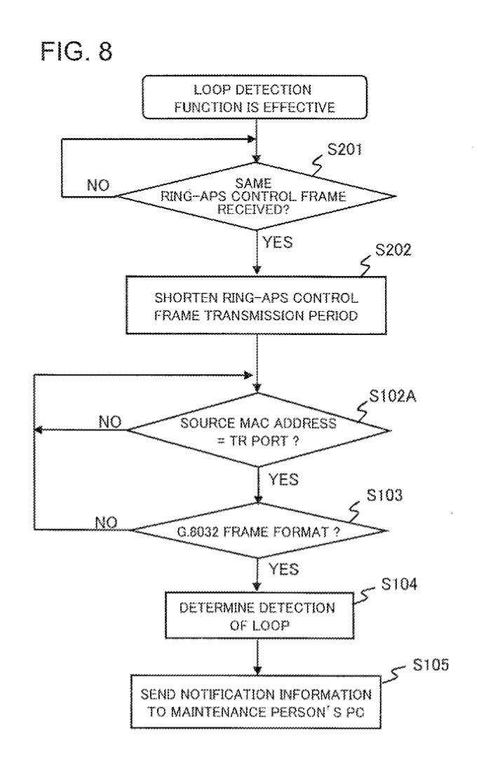

Referring to FIG. 8, while the loop detection function is effective, when the Ring-APS control frame reception sections 53 and 63 receive a Ring-APS control frame whose source MAC address is the same as the MAC address of the output port (Step S201: Yes), the loop detection sections 5 and 6 direct the Ring-APS control frame transmission sections 62 and 52, respectively, to change the periodic interval of Ring-APS control frame transmissions from the defined period to a predetermined shorter period. Upon receipt of this direction for change, the Ring-APS control frame transmission sections 52 and 62 transmit a Ring-APS control frame at the transmission intervals according to that direction (Step S202).

For example, although the Ring-APS control frame transmission period is normally an interval of 5 seconds, Ring-APS control frames are consecutively transmitted at intervals of 3.3 ms after the same Ring-APS control frame is detected, whereby it is possible to reduce the time consumed until the next same Ring-APS control frame is detected.

In this manner, the Ring-APS control frame transmission period is made shorter than the normal transmission period, whereby the above-described loop detection (Step S104) through the MAC address determination (Step S102A) and G.8032 frame determination (Step S103) can be performed more quickly when a loop occurs, making it possible to send notification information to the maintenance person's PC 8 earlier (Step S105).

As described above, according to the present exemplary embodiment, when the same Ring-APS control frame is received, the defined Ring-APS control frame transmission period is changed to a period shorter than normal, whereby failure detection can be performed more quickly.

### 5. Modified Examples

The above-described exemplary embodiments are preferred embodiments of the present invention. The present invention is not limited to these embodiments, and various modifications can be made based on the technical ideas of the present invention.

For example, the cycle at which the Ring-APS control frame transmission sections 52 and 62 transmit a Ring-APS control frame may be any period as long as the period is predetermined, and a configuration may also be made that allows the period to be changed depending on the state of network operation or the like.

Moreover, in the above-described exemplary embodiments, the description has been given using the configurations in which the switch device 1 is connected to two communication lines for each of which the frame determination section is provided. However, the number of ports provided to the switch device is not limited two and may be any number within the range of the performance of the switch device 1. In this case, at least the MAC determination section is implemented for each one of the ports so that one MAC determination section is present for one MAC address.

As described above, the number of communication links connected to the switch device 1 is not particularly limited as long as the configuration is made such that the Ring-APS control frame reception section, Ring-APS control frame transmission section, and frame determination section are provided for each one of the communication links connected to the switch device 1.

In addition, processing procedures for implementing a switch device as any of the above-described exemplary embodiments are recorded as programs which are stored on a recording medium, whereby the above-described functions according to the exemplary embodiments of the present invention can be implemented by causing a computer or a program-controlled processor such as a CPU included in the system to execute the processing through the programs provided from the recording medium.

In this case, the present invention is applicable also when an information group including the programs is provided to an output device from the above-mentioned recording medium or an external recording medium through a network. That is, the program codes read from a recording medium themselves implement new functions of the present invention, and a recording medium storing the program codes and signals read from the recording medium are included in the present invention.

Examples that can be used for the recording medium include flexible disks, hard disks, optical disks, magneto-optical disks, CD-ROM, CD-R, CD-RW, DVD-ROM, DVD-RAM, DVD-RW, DVD+RW, magnetic tape, nonvolatile memory cards, ROM, and the like.

The programs according to the present invention can make a switch device controlled by the programs implement the functions according to the above-described exemplary embodiments.

The present invention can be applied to each node included in a ring network.

The present invention may be embodied in other specific forms without departing from the spirit or essential characteristics thereof. The above-described exemplary embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A switch device in a ring network operating based on a protocol prescribed to prevent occurrence of a loop, comprising:
a transmission section for periodically transmitting a predetermined control frame to a communication line of the ring network, wherein the predetermined control frame conforms to the protocol;
a reception section for receiving a control frame from the ring network; and
a determination section for determining the occurrence of a loop on the communication line when a source address of a received control frame is identical to an address of the transmission section and the received control frame is a predetermined control frame conforming to the protocol.

2. The switch device according to claim 1, wherein the transmission section, the reception section and the determination section are provided for each communication line, wherein the determination section is connected at a stage subsequent to the reception section provided for the communication line and at a stage previous to the transmission section provided for the communication line.

3. The switch device according to claim 2, wherein the determination section previously stores address information of the transmission section, wherein the determination section determines whether the source address of the received control frame is identical to the address information stored.

4. The switch device according to claim 1, wherein, when the received control frame is the same as the predetermined control frame, the determination section changes a period of transmissions of the control frame to a predetermined period shorter than normally prescribed.

5. The switch device according to claim 1, wherein the predetermined control frame is a ring protection control frame defined in the protocol.

6. The switch device according to claim 5, wherein the ring network has a plurality of communication lines which allows redundant switching control.

7. The switch device according to claim 1, wherein the protocol is prescribed in ITU-T recommendation G.8032, wherein the control frame is a Ring-APS control frame defined in the ITU-T recommendation G.8032.

8. A ring network system comprising a plurality of switch devices each according to claim 1.

9. A loop detection method in a switch device of a ring network operating based on a protocol prescribed to prevent occurrence of a loop, comprising:
at a transmission section, periodically transmitting a predetermined control frame to a communication line of the ring network, wherein the predetermined control frame conforms to the protocol; and
at a determination section, determining the occurrence of a loop on the communication line when a source address of a control frame received from the ring network is identical to an address of the transmission section and the received control frame is a predetermined control frame conforming to the protocol.

10. The loop detection method according to claim 9, further comprising: at the determination section, when the received control frame is identical to the predetermined control frame, changing a period of transmissions of the control frame to a predetermined period shorter than normally prescribed.

11. The loop detection method according to claim 9, wherein the predetermined control frame is a ring protection control frame defined in the protocol.

12. The loop detection method according to claim 11, wherein the ring network has a plurality of communication lines which allows redundant switching control.

13. The loop detection method according to claim 9, wherein the protocol is prescribed in ITU-T recommendation G.8032, wherein the control frame is a Ring-APS control frame defined in the ITU-T recommendation G.8032.

14. A recording medium storing a program which instructs a computer to function as a switch device of a ring network operating based on a protocol prescribed to prevent occurrence of a loop, the program comprising:
at a transmission section, periodically transmitting a predetermined control frame to a communication line of the ring network, wherein the predetermined control frame conforms to the protocol; and
at a determination section, determining the occurrence of a loop on the communication line when a source address of a control frame received from the ring network is identical to an address of the transmission section and the received control frame is a predetermined control frame conforming to the protocol.

15. The recording medium according to claim 14, further comprising: at the determination section, when the received control frame is identical to the predetermined control frame, changing a period of transmissions of the control frame to a predetermined period shorter than normally prescribed.

16. The recording medium according to claim 14, wherein the predetermined control frame is a ring protection control frame defined in the protocol.

17. The recording medium according to claim 16, wherein the ring network has a plurality of communication lines which allows redundant switching control.

18. The recording medium according to claim 14, wherein the protocol is prescribed in ITU-T recommendation G.8032, wherein the control frame is a Ring-APS control frame defined in the ITU-T recommendation G.8032.
